(19) United States
(12) Patent Application Publication
(10) Pub. No.: US 2017/0031703 A1
(43) Pub. Date: Feb. 2, 2017

(54) METHOD AND DEVICE FOR UPDATING A VIRTUAL MACHINE OPERATED ON A PHYSICAL MACHINE UNDER A HYPERVISOR

(71) Applicant: Robert Bosch GmbH, Stuttgart (DE)

(72) Inventors: Gunnar Piel, Hemmingen (DE); Gary Morgan, Thixendale (GB)

(21) Appl. No.: 15/221,842

(22) Filed: Jul. 28, 2016

(30) Foreign Application Priority Data
Jul. 29, 2015 (DE) 102015214389.9

(51) Int. Cl. G06F 9/455; G06F 9/445

(52) U.S. Cl. CPC G06F 9/45558; G06F 8/66; G06F 2009/45575; G06F 2009/45583

(57) ABSTRACT

A method for updating a virtual machine operated under a hypervisor on a physical machine having a random-access memory and a read-only memory. The hypervisor operates the virtual machine under an individual diagnostic address, the read-only memory storing a machine code of the hypervisor and of the virtual machine. The virtual machine receives an updating request from an external unit under the diagnostic address with the aid of a communication infrastructure and communicates the updating request to the hypervisor, The hypervisor transfers the machine code from the read-only memory into the random-access memory. The hypervisor starts the virtual machine and executes a boot manager of the virtual machine. The boot manager receives a current machine code under the diagnostic address of the virtual machine and exchanges the machine code in the read-only memory at least partially for the current machine code, and the boot manager restarts the virtual machine.

### CROSS REFERENCE

The present application claims the benefit under 35 U.S.C. §119 of German Patent Application No. DE 102015214389.9 filed on Jul. 29, 2015, which is expressly incorporated herein by reference in its entirety.

### FIELD

The present invention relates to a method for updating a virtual machine operated under a hypervisor on a physical machine having a random-access memory and a read-only memory. The present invention also relates to a corresponding device, a corresponding computer program as well as a corresponding storage medium.

### BACKGROUND INFORMATION

Generally, conventional vehicle control units have capabilities for on-board diagnostics. Typically, the diagnosis supplied in this context relates to the control unit itself, its functionality and software update. These capabilities of generic control units may be accessed, for instance, with the aid of many different vehicle communication networks such as CAN, Flexray or ethernet and specific diagnostic protocols such as OBD. To produce a diagnostic communications link between the control unit and an external diagnostic tool, such a control unit has a diagnostic address. In the case of a single software system within the control unit, the capabilities described can be considered state-of-the-art.

In a virtualized control unit, however, there are several software systems, what are referred to as guest systems, and the additional software components of a hypervisor. As a result, diagnostic capabilities are needed with regard to status information for each guest system, the hardware and the hypervisor. Finally, the guest systems and the hypervisor must be updated.

German Patent No. DE 19921845 A1 describes a diagnostic-test device for motor vehicles, programmable control units in the motor vehicle being provided with self-diagnostic means which, under program control, control and monitor the engine management and other systems of the motor vehicle, generate and store error codes, and which are connectable via a diagnostic/test connector on the motor-vehicle side to an external diagnostic tester. The external diagnostic tester is equipped with a program-recognition and program-loading device. With the aid of the program-recognition device, the program version contained in the connected control unit is queried and recognized. If the program present on the motor-vehicle side in the connected control unit of the vehicle and recognized via the diagnostic/test connector is not stored in the newest and most current version, the latest version in each case is then loaded by the program-loading device of the diagnostic tester into the program memory of the corresponding control unit.

### SUMMARY

The present invention provides a method for updating a virtual machine operated under a hypervisor on a physical machine having a random-access memory and a read-only memory, a corresponding device, a corresponding computer program as well as a corresponding storage medium.

The design according to the present invention is based on the recognition that a virtualized system has more updatable components than a single software system. Here, there are several guest systems and the hypervisor itself, which require updating independently of each other.

An advantage of the approach according to the present invention lies in the retention of existing procedures based on diagnostic communication and diagnostic address as well as boot manager. Thus, each guest system retains its own diagnostic address, and is capable of processing diagnostic communication. The communication infrastructure may either be divided among a plurality of guest systems or reserved exclusively for one guest system.

In this context, the capability of certain embodiments of the invention to update a productive environment in operation is especially advantageous. This means that hypervisors and virtual machines together with the application programs executed by them may continue to be operated normally while a virtual machine or the hypervisor in said place is/are being updated.

The approach presented takes into account the circumstance that most control units—in automotive engineering, for instance, one may think of engine management and body control or electronic stability program—execute their machine code directly from an internal flash memory. During the flash reprogramming carried out within the course of the updating in the case of such units, by using the method described here, application code may be executed during the reprogramming. This proves to be useful in as much as a simultaneous code execution is virtually impossible using a conventional approach.

The guest system may be operated at an increased authorization level and receive the updating request in place of the hypervisor, which ultimately is updated by the boot manager or a bootloader started by it. For purposes of updating, the hypervisor is thus, as it were, assigned to a guest system. In this way, it may be updated together with this particular guest system.

According to one variant, the guest system itself may determine a possible update and initiate it. A corresponding specific embodiment proves to be largely independent of any diagnostic tool.

### BRIEF DESCRIPTION OF THE DRAWINGS

Exemplary embodiments of the present invention are explained in greater detail below and illustrated in the figures.

FIG. 1 shows the data flow chart of a method according to one specific embodiment.

FIG. 2 shows schematically the block diagram of a control unit according to a second specific embodiment together with possible communication partner and infrastructure.

### DETAILED DESCRIPTION OF EXAMPLE EMBODIMENTS

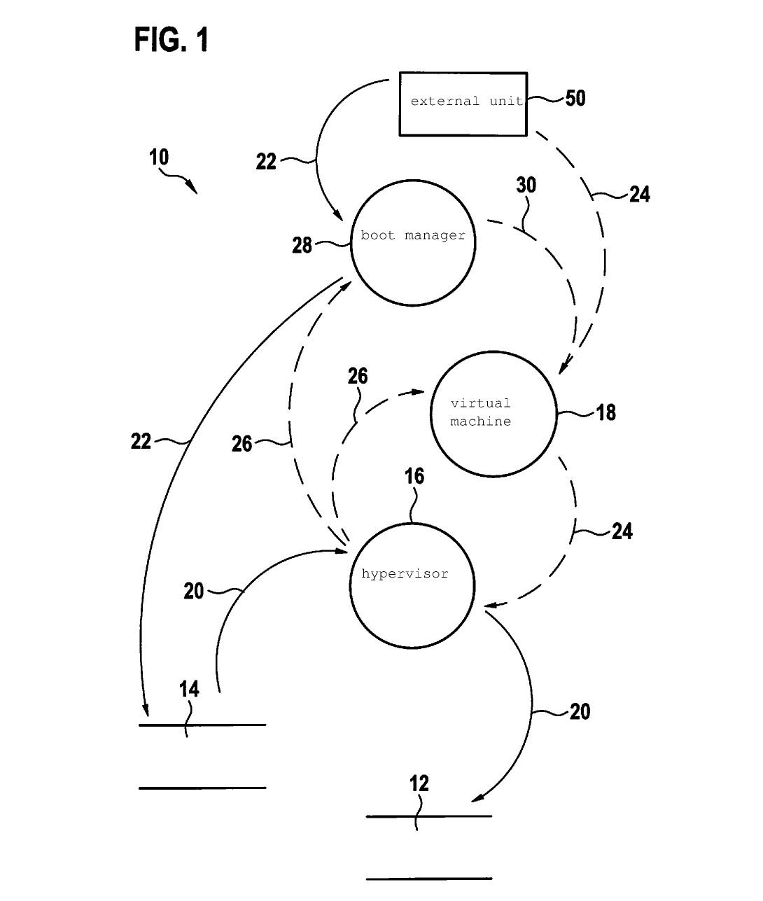

FIG. 1, in a data flow chart according to the Yourdon/DeMarco notation, summarizes the basic procedure of proposed method 10 for updating a virtual machine 18 operated under a hypervisor 16 on a physical machine 38 having a random-access memory 12 and a read-only memory 14. Hypervisor 16 operates virtual machine 18 under an individual diagnostic address, with read-only memory 14 storing a machine code 20 of hypervisor 16 and of virtual machine 18. Virtual machine 18 receives an updating request 24 from an external unit 50 under the diagnostic address with the aid of a communication infrastructure 48 and communicates updating request 24 to hypervisor 16. Hypervisor 16 transfers machine code 20 from read-only memory 14 into random-access memory 12, starts the virtual machine and executes (26) a boot manager 28 of virtual machine 18. Boot manager 28 receives an up-to-date machine code 22 under the diagnostic address of virtual machine 18 and exchanges machine code 20 in read-only memory 14 at least partially for up-to-date machine code 20. Finally, boot manager 28 restarts (30) virtual machine 18.

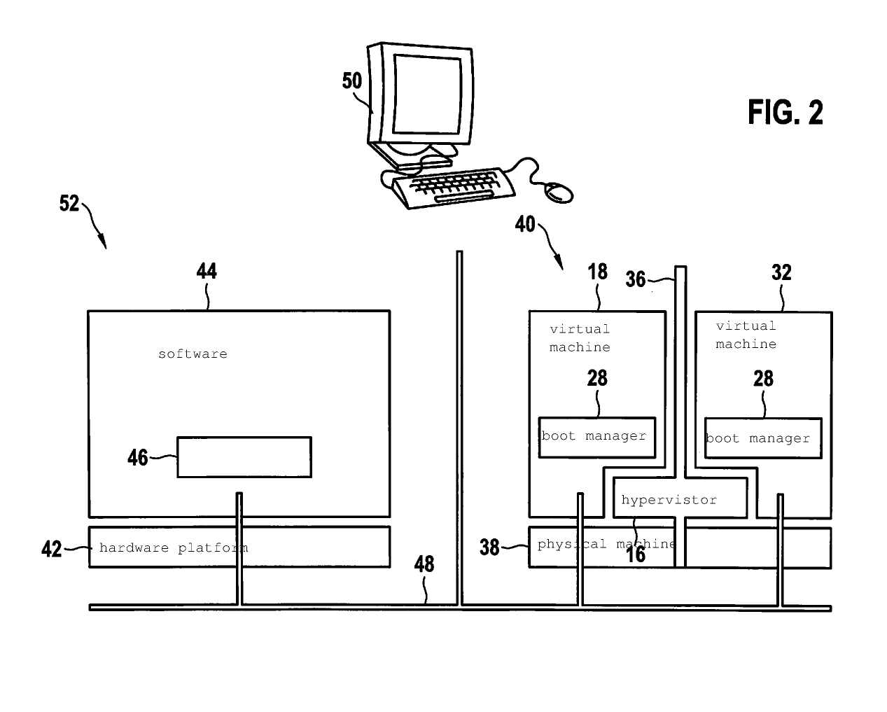

FIG. 2 illustrates a detailed scenario in the context of updating a control unit (electronic control unit, ECU) without its guest systems being taken out of operation.

While a conventional control unit 52 on its hardware platform 42 executes only one software 44 with a single diagnostic address A, in the case of virtualized control unit 40, a hypervisor 16 (virtual machine monitor, VMM) operates a first virtual machine 18 under diagnostic address B and a second virtual machine 32 under diagnostic address C on one joint physical machine 38. Both first virtual machine 18 and second virtual machine 32 are therefore capable of conducting diagnostic communication. Diagnostic address B or diagnostic address C represents both virtual machine 18, 32 operated under it as well as hypervisor 16 itself.

A diagnostic updating request 24 is received under diagnostic address B from an external unit 50, e.g., a diagnostic tester. First virtual machine 18 in question communicates this to hypervisor 16.

Addressed first virtual machine 18 requests of hypervisor 16 the transfer and execution of machine code 20 of hypervisor 16 and first virtual machine 18 from random-access memory (RAM) 12. If the configuration of hypervisor 16 allows it, hypervisor 16 transfers relevant machine code 20 into random-access memory 12, and continues 26 the execution from there. In this context, as a rule, first virtual machine 18 and second virtual machine 32 are only able to be updated within area boundaries 36 of their allocated resources such as storage space, devices and number of processor cores.

If area boundaries 36 are meant to be adapted, hypervisor 16 is therefore to be updated first.

First virtual machine 18 now restarts and executes a boot manager 28 (bootstrap loader, boot loader) from random-access memory 12. Boot manager 28 is reachable under diagnostic address B of first virtual machine 18.

Boot manager 28 thereupon receives further instructions and current machine code 22 in order to carry out the update by way of a diagnostic communication to diagnostic address B of first virtual machine 18 in question. Boot manager 28 selectively updates first virtual machine 18 or hypervisor 16 as a function of updating request 24.

Finally, boot manager 28 restarts first virtual machine 18 (26). The customary boot sequence now continues and restarts first virtual machine 18 (30). If hypervisor 16 was updated, first virtual machine 18 requests a complete system restart from hypervisor 16. In any case, new functionality first becomes active after either the restart of hypervisor 16 or of the system.

What is claimed is:

1. A method for updating a virtual machine operated under a hypervisor on a physical machine having a random-access memory and a read-only memory, the method comprising:
operating the virtual machine, by the hypervisor, under an individual diagnostic address, the read-only memory storing a machine code of the hypervisor and of the virtual machine;
receiving, by the virtual machine, an updating request from an external unit under the diagnostic address with the aid of a communication infrastructure and communicating the updating request to the hypervisor;
transferring, by the hypervisor, the machine code from the read-only memory into the random-access memory;
starting, by the hypervisor, the virtual machine and executing a boot manager of the virtual machine;
receiving, by the boot manager, a current machine code under the diagnostic address of the virtual machine and exchanging the machine code in the read-only memory at least partially for the current machine code; and
restarting, by the boot manager, the virtual machine.

2. The method as recited in claim 1, wherein:
the virtual machine receives the updating request in place of the hypervisor;
the virtual machine is operated at an increased authorization level; and
the machine code is exchanged in such a way that the virtual machine or the hypervisor is selectively updated.

3. The method as recited in claim 2, wherein:
prior to the update, the boot manager receives further instructions under the diagnostic address of the virtual machine with the aid of the communication infrastructure; and
as a function of the further instructions, the machine code is exchanged in such a way that either i) the virtual machine, ii) the hypervisor or ii) the virtual machine and the hypervisor, is updated.

4. The method as recited in claim 3, wherein first the hypervisor and then the virtual machine are updated in such a way that area boundaries of the virtual machine monitored by the hypervisor are transferred.

5. The method as recited in claim 4, wherein the area boundaries limit at least one of the following resources of the physical machine: the random-access memory, peripheral equipment, and processor cores.

6. The method as recited in claim 5, wherein prior to the restart of the virtual machine, the boot manager restarts the hypervisor, if the hypervisor has been updated.

7. The method as recited in claim 1, wherein the read-only memory is an electrically erasable, programmable read-only memory.

8. The method as recited in claim 1, wherein the read-only memory is a flash memory.

9. A machine-readable storage medium on which is stored a computer program for updating a virtual machine operated under a hypervisor on a physical machine having a random-access memory and a read-only memory, the computer program, when executed on a processor, causing the processor to perform:
causing the hypervisor to operate the virtual machine, under an individual diagnostic address, the read-only memory storing a machine code of the hypervisor and of the virtual machine;
causing the virtual machine to receive an updating request from an external unit under the diagnostic address with the aid of a communication infrastructure and communicating the updating request to the hypervisor;
causing the hypervisor to transfer the machine code from the read-only memory into the random-access memory;
causing the hypervisor to start the virtual machine and execute a boot manager of the virtual machine;
causing the boot manager to receive a current machine code under the diagnostic address of the virtual machine and exchange the machine code in the read-only memory at least partially for the current machine code; and
causing the boot manager to restart the virtual machine.

10. A device for updating a virtual machine operated under a hypervisor on a physical machine having a random-access memory and a read-only memory, the device configured to:
cause the hypervisor to operate the virtual machine, under an individual diagnostic address, the read-only memory storing a machine code of the hypervisor and of the virtual machine;
cause the virtual machine to receive an updating request from an external unit under the diagnostic address with the aid of a communication infrastructure and communicate the updating request to the hypervisor;
cause the hypervisor to transfer the machine code from the read-only memory into the random-access memory;
cause the hypervisor to start the virtual machine and execute a boot manager of the virtual machine;
cause the boot manager to receive a current machine code under the diagnostic address of the virtual machine and exchange the machine code in the read-only memory at least partially for the current machine code; and
cause the boot manager to restart the virtual machine.
